(19) United States
(12) Patent Application Publication
(10) Pub. No.: US 2025/0374322 A1
(43) Pub. Date: Dec. 4, 2025

(54) ACCESS POINT AND TERMINAL

(71) Applicant: NIPPON TELEGRAPH AND TELEPHONE CORPORATION, Tokyo (JP)

(72) Inventors: Akira KISHIDA, Musashino-shi (JP); Kengo NAGATA, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/875,292

(22) PCT Filed: Jun. 22, 2022
(86) PCT No.: PCT/JP2022/024867

§ 371 Date: Dec. 16, 2024

(51) Int. Cl. H04W 74/0816; H04W 76/15; H04W 76/30

(52) U.S. Cl. CPC H04W 74/0816; H04W 76/15; H04W 76/30

(57) ABSTRACT

An access point of an embodiment includes a plurality of wireless signal processing units and a management unit. The management unit establishes a plurality of links with a terminal by using the wireless signal processing units, and causes each of the wireless signal processing units to transmit a first wireless signal to the terminal. When one of the wireless signal processing units receives a second wireless signal transmission of the first wireless signal, the management unit causes one of the wireless signal processing units that has received the second wireless signal to wirelessly communicate with the terminal until the end of a specified period.

### TECHNICAL FIELD

An embodiment of the present invention relates to an access point and a terminal.

### BACKGROUND ART

A wireless local area network (LAN) is known as a communication system that wirelessly connects an access point (hereinafter “AP”) and a terminal. The AP and the terminal as wireless stations of the wireless LAN perform carrier sensing based on carrier sense multiple access with collision avoidance (CSMA/CA), and transmit data when a transmission right is obtained.

In IEEE 802.11be under development as a successor standard of IEEE 802.11ax, it is possible to establish a link set including a plurality of links between a terminal and an AP. In a case where the link set including the plurality of links is established, the wireless station performs carrier sensing based on CSMA/CA for each link, and transmits a data frame using the link for which the transmission right has been obtained.

Here in the terminal provided with only one STA function corresponding to a wireless signal processing unit, even if a plurality of links is logically established with the AP, it is physically impossible to transmit data to the AP in parallel with each other by the plurality of links. In a communication system, when uplink data such as traffic for which low latency is required is transmitted from a terminal provided with only one STA function to an AP, redundancy is required to be appropriately performed. That is, it is required to secure reliability in data exchange between a terminal provided with only one STA function and an AP.

### CITATION LIST

### Non Patent Literature

Non Patent Literature 1: IEEE P802.11be™/D1, 5,“35.3.17 Enhanced multi-link single radio operation”, 18, Mar. 2022.

### SUMMARY OF INVENTION

### Technical Problem

An object of the present invention is to provide an access point and a terminal that secure reliability in data exchange between a terminal provided with only one STA function and an access point.

### Solution to Problem

In an embodiment of the present invention, an access point includes a plurality of wireless signal processing units and a management unit. The management unit establishes a plurality of links with a terminal by using a plurality of wireless signal processing units, and causes each of the plurality of wireless signal processing units to transmit a first wireless signal to the terminal. When one of the plurality of wireless signal processing units receives a second wireless signal transmitted from the terminal in response to the transmission of the first wireless signal, the management unit causes one of the plurality of wireless signal processing units that has received the second wireless signal to wirelessly communicate with the terminal until the end of a specified period.

### Advantageous Effects of Invention

According to the present invention, an access point and a terminal that secure reliability in data exchange between a terminal provided with only one STA function and an access point are provided.

### BRIEF DESCRIPTION OF DRAWINGS

FIG. 1 is a block diagram illustrating an example of a configuration of a communication system according to an embodiment.

FIG. 2 is a schematic diagram illustrating an example of link management information between an AP and a terminal in the communication system according to the embodiment.

FIG. 3 is a block diagram illustrating an example of a hardware configuration of the AP according to the embodiment.

FIG. 4 is a block diagram illustrating an example of a hardware configuration of a terminal according to the embodiment.

FIG. 5 is a block diagram illustrating an example of a functional configuration of the AP according to the embodiment.

FIG. 6 is a block diagram illustrating example of a functional configuration of the terminal according to the embodiment.

FIG. 7 is a schematic diagram illustrating an example of a format of a beacon frame generated by a beacon management unit of a communication management unit of the AP according to the embodiment.

FIG. 8 is a block diagram illustrating an example of a functional configuration of channel access function provided in a wireless signal processing unit of the AP according to embodiment.

FIG. 9 is a block diagram illustrating an example of a functional configuration of a channel access function provided in a wireless signal processing unit of the terminal according to the embodiment.

FIG. 10 is a flowchart illustrating example of processing performed by management unit of the AP according to the embodiment when an rTWT function is used.

FIG. 11 is a flowchart illustrating an example of processing performed by the management unit of the terminal according to the embodiment when an rTWT function is used.

FIG. 12 is a schematic diagram illustrating temporal changes in a communication state through a link set between the AP and the terminal in the communication system according to the embodiment.

FIG. 13 is a flowchart illustrating an example of processing performed by the management unit of the AP according to a modification when an rTWT function is used.

FIG. 14 is a flowchart illustrating an example of processing performed by the management unit of the terminal according to the modification when an rTWT function is used.

FIG. 15 is a schematic diagram illustrating temporal changes in a communication state through a link set between the AP and the terminal in the communication system according to the modification.

### DESCRIPTION OF EMBODIMENTS

Hereinafter, an embodiment of the present invention is described with reference to the drawings.

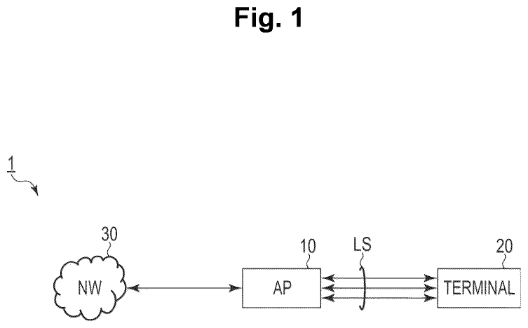

FIG. 1 is a block diagram illustrating an example of the configuration of a communication system 1 according to the embodiment. As illustrated in FIG. 1, the communication system 1 includes an access point (hereinafter “AP”) 10, a terminal 20, and a network 30. The AP 10 is also referred to as a “base station” of a wireless LAN. The AP 10 communicates with a server (not illustrated) on the network 30 in a wired or wireless manner. The terminal 20 is, for example, any of a smart phone, a mobile phone, a tablet personal computer (PC), a desktop PC, a laptop PC, and an Internet of things (IoT) sensor/device.

The AP 10 can be wirelessly connected to the terminal 20 and wirelessly communicates with the terminal 20. The wireless communication between the terminal 20 and the AP 10 is based on the IEEE 802.11 standard. Note that although the wireless communication based on the IEEE 802.11 standard is described as an example in the following description, a wireless communication standard different from the IEEE 802.11 standard may be used.

Each of the AP 10 and the terminal 20 has, for example a wireless communication function based an open systems interconnection (OSI) reference model defined n the IEEE 802.11 standard. In the OSI reference model, the wireless communication function is divided into seven layers (the first layer: a physical layer, the second layer: a data link layer, the third layer: a network layer, the fourth layer: a transport layer, the fifth layer: a session layer, the sixth layer: a presentation layer, and the seventh layer: an application layer). A data link layer as the second layer includes the logical link control (LLC) sublayer and the media access control (MAC) sublayer.

In the wireless connection between the AP 10 and the terminal 20, a link set LS including a plurality of links is established. Each of the plurality of links of the link set LS is established using the STA function provided as a functional configuration in each of the AP 10 and the terminal 20. The AP 10 is provided with a plurality of STA functions, and the terminal 20 is provided with only one STA function. In each of the AP 10 and the terminal 20, the STA function corresponds to a wireless signal processing unit described below.

One of the STA functions of the AP 10 and the STA function of the terminal 20 are used to establish one link. Therefore, each of the plurality of links of the link set LS is established using the corresponding one of the plurality of STA functions of the AP 10 and the STA function of the terminal 20. Accordingly, the only one STA function provided in the terminal 20 is used to establish all the links constituting the link set LS.

In the link set LS established between the AP 10 and the terminal 20 as described above, data can be transmitted from the AP 10 to the terminal 20 in parallel with each other by the plurality of links. However, in the link set LS, data cannot be transmitted from the terminal 20 to the AP 10 in parallel with each other by the plurality of links. That is, at the same timing, uplink data or the like can be transmitted from the terminal 20 to the AP 10 only through one of the plurality of links of the link set LS. The terminal 20 can receive downlink data by the plurality of links of the link set LS. Note that the terminal 20 can receive a management frame to be described below in parallel with each other by the plurality of links of the link set LS, but may be configured to be able to receive data only by any one of the plurality of links.

Here, the only one STA function provided as a wireless signal processing unit in the terminal 20 is also referred to as an “enhanced STA (ESTA) function”. In addition, a terminal such as the terminal 20 in which only one ESTA function is provided as the STA function is also referred to as a “single radio (SR) terminal”. Then, the function of establishing the link set LS between the AP 10 and the terminal 20, which is an SR terminal, as described above and performing the wireless communication between the AP 10 and the terminal 20 using the link set LS as described above is also referred to as an “enhanced multi-link single radio (EMLSR) function”. The AP 10 and the terminal 20 manage the state of the link between the AP 10 and the terminal 20 including the state of the link set LS according to link management information.

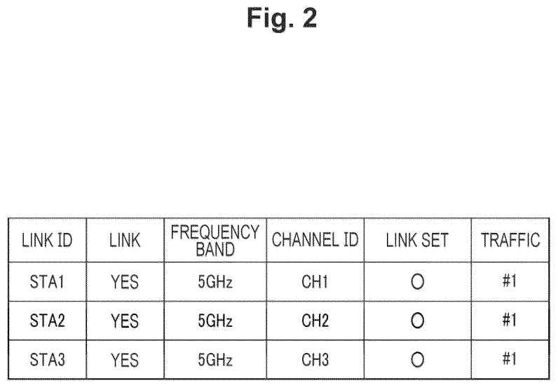

FIG. 2 is a schematic diagram illustrating an example of link management information between the AP 10 and the terminal 20 in the communication system 1 according to the employment. The link management information indicates, for example, information of each of “link ID”, “line”, “frequency band”, “channel ID”, “link set”, and “traffic”. The “link ID” is an identifier associated with the above-described STA function of the AP 10. In the example of FIG. 2, in the AP 10, three STA functions (STA1, STA2, and STA3) are allocated to wireless communication with the terminal 20. The information regarding “link” indicates whether or not each of the plurality of STA functions of the AP 10 has established a link with the terminal 20. In the example of FIG. 2, a state in which each of STA1 to STA3 of the AP 10 has established a link with the terminal 20 is illustrated

The information regarding “frequency band” indicates a frequency band allocated to each link. As the frequency band, for example, the 6 GHz band, the 5 GHz band, the 2.4 GHz band can applied. Each of the plurality of frequency bands includes a plurality of channels. “Channel ID” indicates an ID of a channel allocated to each of the links. In the example of FIG. 2, a channel CH1 in the 5 GHz band, a channel CH2 in the 5 GHz band, and a channel CH3 in the 5 GHz band are allocated to the link corresponding to STA1, the link corresponding to STA2, and the link corresponding to STA3, respectively. Note that, in the plurality of links of the link set LS, different frequency bands may be allocated, or different channels of the same frequency band may be allocated.

The information regarding “link set” indicates whether or not the link set LS including the plurality of links is established, between the AP 10 and the terminal 20.

In addition, in a case where the link set LS is established, the information regarding “link set” indicates which links constitute the link set LS. In the example of FIG. 2, the link set LS includes the links: the link corresponding to STA1, the link corresponding to STA2, and the link corresponding to STA3.

The information regarding “traffic” indicates a traffic indicator (TID) ted to each of the links (each of the STA functions of the AP 10). The TID is an identifier indicating each traffic, and each traffic may be associated with an access category. The access category of the traffic includes, for example, “voice (VO)”, “video (VI)”, “best effort (BE)”, “background (BK”, and “low latency (LL)”. The access category LL is for which low latency (low delay) is required. In the example of FIG. 2, TID #1 corresponds to any of VO, VI, BE, BK, and LL. Then, TID #1 is allocated to each of the link corresponding to STA1, the link corresponding to STA2, and the link corresponding to STA3.

Here, in the state where the link set LS is established, data can be transmitted from the AP 10 to the terminal 20 in parallel with each other by the plurality of links of the link set LS. For example, for downlink data from the AP 10 to the terminal 20, although not limited thereto, only one link of the link set LS may be allocated to one TID, or a plurality of links of the link set LS may be allocated. In addition, the association between the traffic and the link (STA function of the AP 10) is set such that a traffic amount (data amount) is equal among the plurality of links constituting the link set LS. Note that the association between the traffic and the link is not limited to the example described above. For example, traffic of types similar to each other, such as traffic for which low latency is required and traffic for which low latency is not required, may be collected in a specific link of the link set LS.

In addition, the AP 10 and the terminal 20 have a restricted target wake time (rTWT) function. When the AP 10 and the terminal 20 use the rTWT function, a transmission opportunity of traffic (uplink data) for which low latency is required from the terminal 20 to the AP 10 is secured in the link set LS established between the AP 10 and the terminal 20. A service period in which transmission and reception of traffic for which low latency is required can be prioritized over transmission and reception of traffic for which low latency is not required is set as specified period by the rTWT function. The above-described service period set as the specified period by the rTWT function is also referred to as a “rTWT-service period (SP)”.

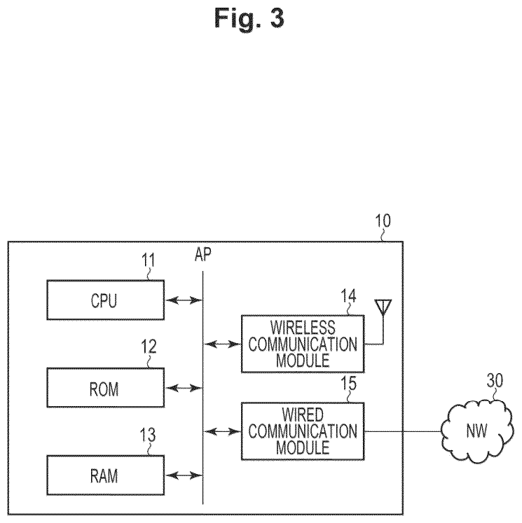

FIG. 3 is a block diagram illustrating an example of a hardware configuration of the AP 10 according to the embodiment. As illustrated in FIG. 3, the AP 10 includes, for example, a central processing unit (CPU) 11, read only memory (ROM) 12, random access memory (RAM) 13, a wireless communication module 14, and a wired communication module 15.

The CPU 11 is a processing circuit that controls the entire operation of the AP 10. The ROM 12 is, for example, a nonvolatile semiconductor memory. The ROM 12 stores programs and data for controlling the AP 10. The RAM 13 is, for example, a volatile semiconductor memory. The RAM 13 is used as a working area of the CPU 11. The wireless communication module 14 is a circuit used to transmit and receive data by a wireless signal. The wireless communication module 14 is connected to an antenna. The wired communication module 15 is a circuit used to transmit and receive data by a wired signal. The wired communication module 15 is connected to the network 30.

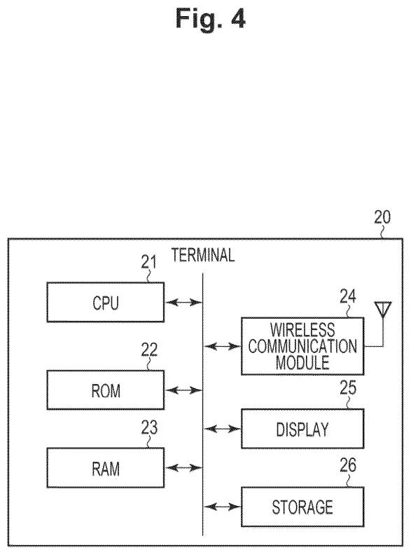

FIG. 4 is a block diagram illustrating an example of a hardware configuration of the terminal 20 according to the embodiment. As illustrated in FIG. 4, the terminal 20 includes, for example, a CPU 21, ROM 22, RAM 23, a wireless communication module 24, a display 25, and a storage 26.

The CPU 21 is a processing circuit that controls the entire operation of the terminal 20. The ROM 22 is a nonvolatile semiconductor memory. The ROM 22 stores programs and data for controlling the terminal 20. The RAM 23 is, for example, a volatile semiconductor memory. The RAM 23 is used as a working area of the CPU 21. The wireless communication module 24 is a circuit used to transmit and receive data by a wireless signal. The wireless communication module 24 is connected to an antenna. The display 25 is, for example, a liquid crystal display (LCD) or an electro-luminescence (EL) display. The display 25 displays a graphical user interface (GUI) corresponding to application software, or the like. The storage 26 is a nonvolatile storage device. The storage 26 stores system software and the like of the terminal 20.

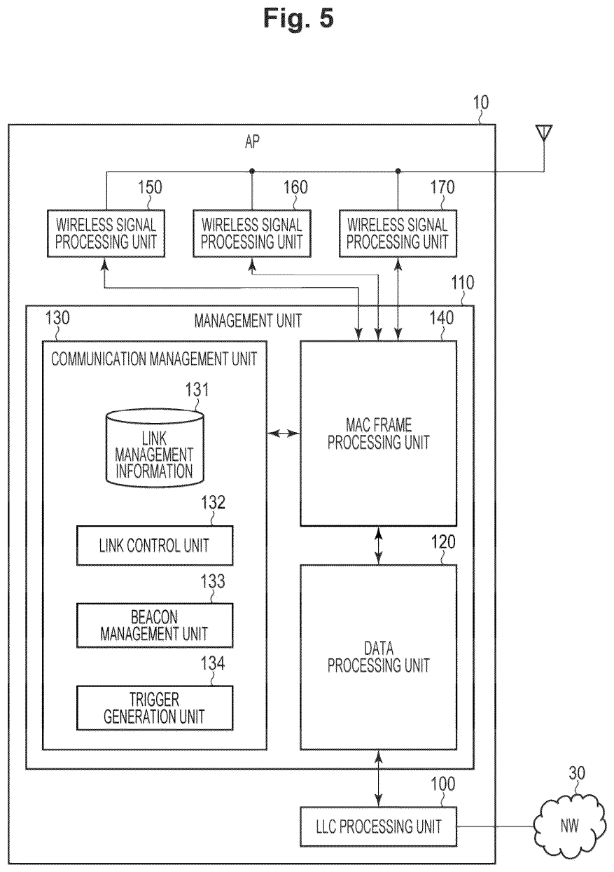

FIG. 5 is a block diagram illustrating an example of a functional configuration of the AP 10 according to the embodiment. As illustrated in FIG. 5, the AP 10 includes an LLC processing unit 100, a management unit 110, and wireless signal processing units 150, 160, and 170. The processing of the LLC processing unit 100 can be implemented by a combination of the CPU 11, the RAM 13, and the wired communication module 15. The processing of the management unit 110 and each of the wireless signal processing units 150, 160, and 170 can be implemented by, for example, a combination of the CPU 11, the RAM 13, and the wireless communication module 14. The LLC processing unit 100 executes, for example, processing of the LLC sublayer of the second layer and processing of the third layer to the seventh layer. The management unit 110 executes processing of the MAC sublayer of the second layer. The wireless signal processing units 150, 160, and 170 execute processing of the MAC sublayer of the second layer and processing of the first layer. The management unit 110 includes a data processing unit 120, a communication management unit 130, and a MAC frame processing unit 140.

The LLC processing unit 100 adds a destination service access point (DSAP) header, a source service access point (SSAP) header, and the like to the data received from the network 30 to generate an LLC packet. Then, the LLC processing unit 100 inputs the generated LLC packet to the data processing unit 120. In addition, the LLC processing unit 100 receives the LLC packet from the data processing unit 120 and extracts data from the received LLC packet. Then, the LLC processing unit 100 transmits the extracted data to the network 30.

The data processing unit 120 adds a MAC header to the LLC packet input from the LLC processing unit 100 to generate a MAC frame. Then, the data processing unit 120 inputs the generated MAC frame to the MAC frame processing unit 140. In addition, the data processing unit 120 receives the MAC frame from the processing unit 140 and extracts the LLC packet from the received MAC frame. Then, the data processing unit 120 inputs the extracted LLC packet to the LLC processing unit 100. In the following description, the MAC frame including data is also referred to as a “data frame”.

The communication management unit 130 manages the communication state between the AP 10 and the terminal 20 including the state of the link between the AP 10 and the terminal 20. A MAC frame including management information related to wireless communication such as management information related to a link, rTWT, and the like is input and output between the communication management unit 130 and the MAC frame processing unit 140. In the following description, the MAC frame including management information is also referred to as a “management frame”. The communication management unit 130 can instruct the MAC frame processing unit 140. The communication management unit 130 includes, for example, link management information 131, a link control unit 132, a beacon management unit 133, and a trigger generation unit 134. In addition, the communication management unit 130 includes a clock and the like, and can generate time information.

When a MAC frame is input from the date processing unit 120 or the communication management unit 130, the MAC frame processing unit 140 associates the input MAC frame with a link. Then, for the MAC frame transmitted to the terminal 20, the MAC frame unit 140 specifies a link associated with the MAC frame among the links of the link set LS. For example, when a data frame is input as a MAC frame from the data processing unit 120, the MAC frame processing unit 140 specifies a link associated with a TID included in the data frame. Then, the MAC frame processing unit 140 inputs the MAC frame to the wireless signal processing unit (corresponding one or more of 150, 160, and 170) corresponding to the specified link.

In addition, when the MAC frame is input from one of the wireless signal processing units 150, 160, and 170, the MAC frame processing unit 140 inputs the MAC frame to the data processing unit 120 or the communication management unit 130 in accordance with the type of the input MAC frame. In a case where the MAC frame is a data frame, the MAC frame is input to the data processing unit 120, and in a case where the MAC frame is a management frame, the MAC frame is input to the communication management unit 130.

The wireless signal processing units 150, 160, and 170 correspond to STA1, STA2, and STA3 illustrated in FIG. 2, which are STA functions of the AP 10, respectively. The wireless signal processing units 150, 160, and 170 have a similar functional configuration with respect to each other. Each of the wireless signal processing units 150, 160, and 170 adds a preamble, a physical layer (PHY) header, and the like to the data input from the MAC frame processing unit 140 to generate a wireless frame. Then each of the wireless signal processing units 0, 160, and 170 performs a predetermined modulation operation on the generated wireless frame to convert the wireless frame into a wireless signal, and radiates (transmits) the wireless signal via the antenna. The predetermined modulation operation includes convolutional coding interleaving, subcarrier modulation, inverse fast Fourier transform (IFFT), orthogonal frequency division multiplexing (OFDM) modulation, and frequency conversion, for example.

In addition, each of the plurality of wireless signal processing units 150, 160, and 170 converts a wireless signal from the terminal 20 received via the antenna into a wireless frame by performing predetermined demodulation operation. The predetermined demodulation operation includes frequency conversion, OFDM demodulation, fast Fourier transform (FFT), subcarrier demodulation, deinterleaving, and Viterbi decoding, for example. Then, the wireless signal processing unit 150 extracts the MAC frame from the wireless frame, and inputs the extracted MAC frame to the MAC frame processing unit 140. Note that the wireless signal processing units 150, 160, and 170 may share the same antenna or may use different antennas.

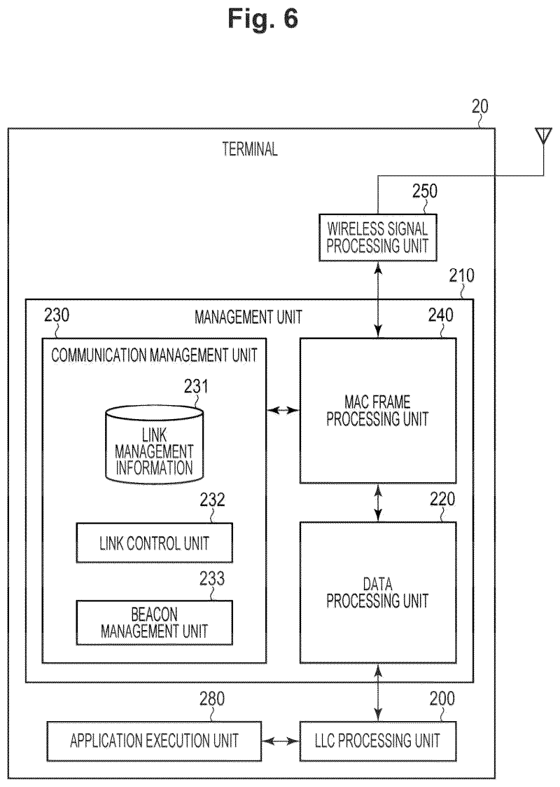

FIG. 6 is a block diagram illustrating an example of a functional configuration of the terminal 20 according to the embodiment. As illustrated in FIG. 6, the terminal 20 includes, for example, an application execution unit 280, an LLC processing unit 200, a management unit 210, and the wireless signal processing unit 250. Processing of each of the application execution unit 280 and the LLC processing unit 200 can be implemented by, for example, the CPU 21 and the RAM 23. The processing of each of the management unit 210 and the wireless signal processing unit 250 can be implemented by, for example, a combination of the CPU 21, the RAM 23, and the wireless communication module 24. The application execution unit 280 executes processing of the seventh layer, the LLC processing unit 200 executes processing of the LLC sublayer of the second layer and processing of the third layer to the sixth layer. The management unit 210 executes processing of the MAC sublayer of the second layer, and the wireless signal processing unit 250 executes processing of the MAC sublayer of the second layer and processing of the first layer. The management unit 210 includes a data processing unit 220, a communication management unit 230, and a MAC frame processing unit 240.

The application execution unit 280 executes an application on the basis of data input from the LLC processing unit 200. In addition, the application execution unit 280 inputs data to the LLC processing unit 200 in accordance with the operation of the application. The application execution unit 280 can display application information on the display 25. In addition, the application execution unit 280 can execute processing in accordance with an operation by the input interface.

The LLC processing unit 200 adds a DSAP header, an SSAP header, and the like to data received from the application execution unit 280 to generate an LLC packet. Then, the LLC processing unit 200 inputs the generated LLC packet to the data processing unit 220. In addition, the LLC processing unit 200 receives the LLC packet from the data processing unit 220 and extracts data from the received LLC packet. Then, the LLC processing unit 200 inputs the extracted data to the application execution unit 280.

The data processing unit 220 adds a MAC header to the LLC packet input from the LLC processing unit 200 to generate MAC frame. Then, the data processing unit 220 inputs the generated MAC frame to the MAC frame processing unit 240. In addition, the data processing unit 220 receives the MAC frame from the MAC frame processing unit 240 and extracts the LLC packet from the received MAC frame. Then, the data processing unit 220 inputs the extracted LLC packet to the LLC processing unit 200.

The communication management unit 230 manages the communication state bet the AP 10 and the terminal 20 including the state of the link between the AP 10 and the terminal 20 in cooperation with the communication management unit 130 of AP 10. A MAC frame (management frame) including management information related to wireless communication such as management information related to a link, rTWT, and the like is input and output between the communication management unit 230 and the MAC frame processing unit 240. The communication management unit 230 can instruct the MAC frame processing unit 240 to execute predetermined processing by outputting the management frame to the MAC frame processing unit 240. The communication management unit 230 includes, for example, link management information 231, a link control unit 232, and a beacon management unit 233.

When a MAC frame is input from the data processing unit 220 or the communication management unit 230, the MAC frame processing unit 240 associates the input MAC frame with a link. Then, for the MAC frame transmitted to the AP 10, the MAC frame processing unit 240 specified a link set LS. For example when a data is input from the data processing unit 220, the MAC frame processing unit 240 specifies a link associated with a TID included in the data frame. Then, the MAC frame processing unit 140 inputs the MAC frame to the wireless signal processing unit 250 together with an instruction to transmit by the specified link to the wireless signal processing unit 250.

In addition, when the MAC frame is input from the wireless signal processing unit 250, the MAC frame processing unit 240 inputs the MAC frame to the data processing unit 220 or the communication management unit 230 in accordance with the type of the input MAC frame. In a case where the MAC frame is a data frame, the MAC frame is input to the data processing unit 220, and in a case where the MAC frame is a management frame, the MAC frame is input to the communication management unit 230.

The wireless signal processing unit 250 corresponds to the ESTA, which is only one STA function provided in the terminal 20. Therefore, the wireless signal processing unit 250 establishes a plurality of links constituting the link set LS with the AP 10. The wireless signal processing unit 250 adds a preamble, a physical layer (PHY) header, and the like to the data input from the MAC frame processing unit 240 to generate a wireless frame. Then, the wireless signal processing unit 250 performs a predetermined modulation operation on the wireless frame to convert the wireless frame into a wireless signal, and radiates (transmits) the wireless signal via the antenna. The predetermined modulation operation is performed similarly to the predetermined modulation operation in each of the wireless signal processing units 150, 160, and 170.

The wireless signal processing unit 260 transmits the wireless signal using a corresponding one of the plurality of links (plurality of channels) of the link set LS. Note that, in the wireless signal processing unit 250, as described above, it is impossible to transmit wireless signals in parallel with each other by the plurality of links constituting the link set LS.

In addition, the wireless signal processing unit 250 converts a wireless signal from the AP 10 received via the antenna into a wireless frame by performing predetermined demodulation operation. The predetermined demodulation operation is performed similarly to the predetermined demodulation operation in each of the wireless signal processing units 150, 160, and 170. Then, the wireless signal processing unit 250 extracts the MAC frame from the wireless frame, and inputs the extracted MAC frame to the MAC frame processing unit 240. In one example, the wireless signal processing unit 250 monitors each of the links (channels) of the link set LS, and when detecting a wireless signal on any of the links, inputs a MAC frame corresponding to the detected wireless signal to the MAC frame processing unit 240.

In addition, when detecting a wireless signal from the AP 10 on any of the links, the wireless signal processing unit 250 specifies a link (channel) on which the wireless signal is detected. Then, in addition to the MAC frame corresponding to the wireless signal, information indicating on which link the wireless signal is received is input to the MAC frame processing unit 240. In addition, the wireless signal processing unit 250 can receive wireless signals in parallel with each other by a plurality of links constituting the link set LS, that is, at the same timing with respect to each other. Note that, in the wireless signal processing unit 250, the antenna may be shared by the plurality of links (plurality of channels) of the link set LS, or one antenna may be provided for each of the plurality of links.

In the functional configurations illustrated in FIGS. 5 and 6, the link control unit 132 of the AP 10 and the link control unit 232 of the terminal 20 cooperate with each other to control establishment of a link between the AP 10 and the terminal 20. In the control of the establishment of the link, for example, the link control units 132 and 232 execute association processing and authentication processing subsequent to the association processing in response to a connection request from the terminal 20 to the AP 10. The link control units 132 and 232 control the state of t link established between the AP 10 and the terminal 20. For example, the link control units 132 and 232 can determine association between the TID and the link (STA function of the AP 10) when the link set LS is established between the AP 10 and the terminal 20.

In addition, in the control of the establishment of the link and the control of the established link, the link control unit 132 refers to the link management information 131, and the link control unit 232 refers to the link management information 231. Each piece of the link management information 131 and 231 includes information related to a link the AP 10 and the terminal 20, and includes, for example, the information illustrated in FIG. 2.

In addition, in a state where the link set LS is not established, the link control units 132 and 232 cooperate with each other to set up the link set LS. In the setup of the link set LS, any one of the wireless signal processing units 150, 160, and 170 (STA1 to STA3) of the AP 10 communicates with the wireless signal processing unit 250 (ESTA) of the terminal 20. In one example, in the setup of the link set LS, the link control unit 232 causes a probe request to be transmitted from the terminal 20 to the AP 10, and the link control unit 132 causes a probe response to be transmitted from the AP 10 to the terminal 20 as a response to the probe request. Then, when the terminal 20 receives the probe response, the link control unit 232 causes an association request for the link set LS to be transmitted from the terminal 20 to the AP 10.

When the AP 10 receives the association request, the link control unit 132 performs association processing on the link set LS. At this time, the link control unit 132 recognizes that the link set LS is established between the AP 10 and the terminal 20 on the basis of completion of the association processing for two or more STA functions of the AP 10. When the association processing is completed, the link control unit 132 updates the link management information 131. Then, the link control unit 132 causes a response indicating that the link set LS is established to be transmitted from the AP 10 to the terminal 20. Then, the link control unit 232 updates the link management information 231 on the basis of reception of response indicating establishment of the link set LS the terminal 20.

In addition, in a state where the link set LS is established between the AP 10 and the terminal 20 as described above, the communication management unit 130 of the AP 10 and the communication management unit 230 of he terminal 20 cooperate with each other to set up the rTWT function. The setup of the rTWT function may be performed immediately after the setup of the link set LS is performed, or may be performed on the basis of a transmission request, from the terminal 20, of traffic for which low latency is required. Parameters related to the rTWT function are set by the setup of the rTWT function, and the rTWT-SP that is the specified period described above is set on the basis of the set parameters. Data exchange between the AP 10 and the terminal 20 in the rTWT-SP is performed by using any one of plurality of links constituting the set up link set LS.

In the setup of the rTWT function, for example, rTWT start time, rTWT cycle, and rTWT duration are set as the parameters related to the rTWT function. The rTWT start time corresponds to the time at the start of the rTWT-SP. The rTWT cycle corresponds to the cycle of the rTWT-SP and is also referred to as “rTWT interval”. The rTWT duration corresponds to a length of the rTWT-SP. Note that the rTWT start time can be calculated on the basis of the set rTWT cycle. For example, the time obtained by adding the set rTWT cycle to the previous rTWT start time is the next rTWT start time.

For example, the communication management units 130 and 230 set the parameters related to the rTWT function in association with a transmission cycle, from the terminal 20, of traffic for which low latency is required. A method for acquiring the transmission cycle, from the terminal 20, of the traffic for which low latency is required is not particularly limited. In one example, a data generation cycle set in an application that generates data requiring low latency is acquired in the terminal 20, and the parameters related to the rTWT function are set.

The beacon management unit 133 manages information transmitted as beacon signal by the AP 10. For example, in a state where the rTWT function used, the beacon management unit 133 generates a management frame including management information related to the rTWT function, and inputs the generated management frame to the MAC frame processing unit 140. The management information related to the rTWT function includes setting values for the parameters related to the rTWT function set as described above. In the following description, the management frame generated by the beacon management unit 133 is also referred to as a “beacon frame”.

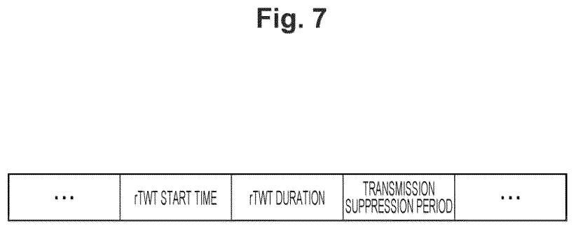

FIG. 7 is a schematic diagram illustrating an example of a format of a beacon frame generated by the beacon management unit 133 of the communication management unit 130 of the AP 10 according to the embodiment. In the example of FIG. 7, the beacon frame includes setting values of the rTWT start time and the rTWT duration as the management information related to the rTWT function. In addition, in the example of FIG. 7, a Quiet frame that causes a terminal other than the terminal 20 to suppress transmission of data to the AP 10 is included in the beacon frame. The Quiet frame indicates a transmission suppression period during which a terminal other than terminal 20 is caused to suppress data transmission. The transmission suppression period for a terminal other than the terminal 20 is set to match the rTWT-SP of the terminal 20. The communication management unit 130 causes the AP 10 to transmit a beacon signal obtained by converting the beacon frame into a wireless signal to the terminal 20 and each of the terminals other than the terminal 20.

In the functional configurations illustrated in FIGS. 5 and 6, the beacon management unit 233 of the terminal 20 manages information included in the beacon signal received from the AP 10. For example the above-described beacon frame is input from the MAC frame processing unit 240 to the beacon management unit 233 in a state where the rTWT function is used. Then, the beacon management unit 233 extracts the management information related to the rTWT function from the input beacon frame. As a result, the beacon management unit 233 acquires the setting values of the parameter related to the rTWT function, and manages the management information related to the rTWT function including the setting values of the parameters related to the rTWT function.

The trigger generation unit 134 generates a MAC frame including trigger information and inputs the MAC frame to the MAC frame processing unit 140. The trigger information instructs the terminal 20 to transmit uplink data requiring low latency when the rTWT function is used. In addition a notification of the start of the rTWT-SP is given to the terminal 20 by the trigger information. The trigger information indicates a resource allocated to the transmission of the uplink data from the terminal 20 in the rTWT-SP. For example, in the trigger information, a link (frequency band and channel), timing, a period, and the like allocated to the transmission of the uplink data from the terminal 20 in the rTWT-SP are indicated as the allocated resources. In the following description, the management frame including the trigger information is also referred to as a “trigger frame”.

Note that, instead of generating the trigger frame, the trigger generation unit 134 may instruct the MAC frame processing unit 140 to generate the trigger frame together with designation of time. In addition, when the rTWT function is used, a trigger signal obtained by converting the trigger frame into wireless signal is transmitted from the AP 10 to the terminal 20. Then, the trigger generation unit 134 generates the trigger frame or gives an instruction on generation of the trigger frame in a state where the trigger signal is transmitted from the AP 10 at the start of the rTWT-SP, that is, at the rTWT start time. In addition, the resource allocation in the transmission of the uplink data from the terminal 20 may be performed by the management unit 110 such as the communication management unit 130 and the MAC frame processing unit 140, or may be performed by the wireless signal processing unit (corresponding one or more of 150, 160, and 170) that transmits the trigger signal.

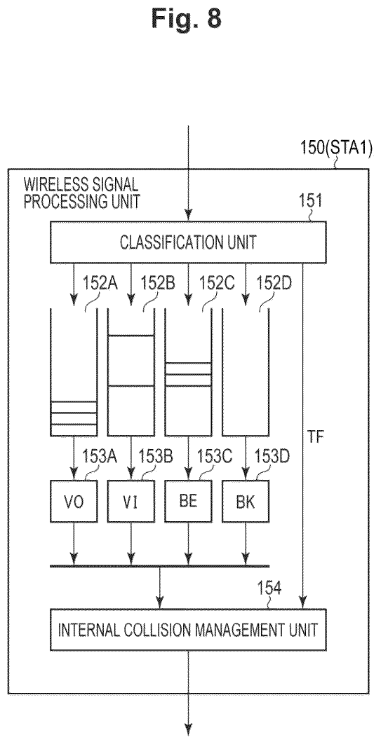

FIG. 8 is a block diagram illustrating an example of a functional configuration of a channel access function of the AP 10 according to the embodiment. In the example of FIG. 8, each of the wireless signal processing units 150, 160, and 170 (STA1 to STA3) is provided with the channel access function. Then, each of the three channel access functions checks a situation of corresponding one of the links of the link set LS. Here, FIG. 8 illustrates the channel access function provided in the wireless signal processing unit 150, and the channel access function of the wireless signal processing unit 150 will be mainly described in the following description. However, the channel access function provided in each of the wireless signal processing units 160 and 170 also performs processing similar to the channel access function of the wireless signal processing unit 150. In addition, in another example, the channel access function may be provided in the MAC frame processing unit 140 instead of being provided in each of the wireless signal processing units 150, 160, and 170. In this case, the situations of all the links (all the channels) of the link set LS are checked by one channel access function of the MAC frame processing unit 140. As illustrated FIG. 8, the channel access function includes, for example, a classification unit 151, queues 152A, 1528, 152C, and 152D, carrier sensing execution units 153A, 1538, 153C, and 153D, and an internal collision management unit 154.

In the example of FIG. 8, when a data frame as a MAC frame is input to the channel access function, the classification unit 151 classifies the input data frame into a plurality of access categories on the basis of the TID included in the MAC header. Then, the classification unit 151 inputs the data frame to one corresponding access category of the queues 152A to 152D. As a result, the data frame is input to the queue (corresponding one of 152A to 152D) corresponding to the access category to which the data frame is classified. In the example of FIG. 8, the data frames whose access categories are VO, VI, BE, and BK are input to the queues 152A, 152B, 152C, and 152D, respectively.

Each of the queues 152A to 152D buffers the input data frame. In the example of FIG. 8, the queues 152A, 152B, 152C, and 152D buffer the data frames whose access categories are VO, VI, BB, and BK, respectively. The carrier sensing execution units 153A, 153B, 153C, and 153D are provided corresponding to the queues 152A, 152B, 152C, and 152D, respectively. Each of the carrier sensing execution units 153A to 153D executes carrier sensing based on CSMA/CA according to access parameters set in advance. The carrier sensing execution units 153A, 153B, 153C, and 153D performs carrier sensing with VO, VI, BE, and BK as corresponding access categories, respectively.

The access parameters are set for each access category, and are set, for example, such that transmission of a wireless signal is prioritized in the order of VO, VI, BE, and BK. As the access parameters, for example, CWmin CWmax, Arbitration Inter Frame Space (AIFS), and Transmission Opportunity (TXOP) Limit are used. CWmin and CWmax indicate a minimum value and a maximum value of a contention window, which are parameters used to set a transmission wait time for collision avoidance, respectively. AIFS indicates a fixed transmission wait time set for each access category. TXOPLimit indicates an upper limit value of the channel occupancy time TXOP. Therefore, for the access category in which the values of CWmin, CWmax, and AIFS are set to be shorter, the transmission right can be more easily obtained, and for the access category in which the value of TXOPLimit is set to be larger, the amount of data transmitted with one transmission right is larger.

Each of the carrier sensing execution units 153A to 153D checks, by carrier sensing, the situation of one corresponding to the wireless signal processing unit 150 of the plurality of links (channels) constituting the link set LS. At this time, as long as the channel corresponding to the link whose situation is being checked in is a busy state, that is, until the channel corresponding to the link whose situation is being checked is in an idle state, each of the carrier sensing execution units 153A to 153D continues the carrier sensing. Then, when the channel corresponding to the link whose situation is being checked is in an idle state and the transmission right is obtained on the link whose situation is being checked, each of the carrier sensing execution units 153A to 153D extracts the data frame from the corresponding one of the queues 152A to 152D. Then, each of the carrier sensing execution units 153A to 153D transmits the wireless signal obtained by converting the data frame to the terminal 20 through the link that has obtained the transmission right, that is, from the wireless signal processing unit 150.

In a case where a plurality of the carrier sensing execution units 153A to 153D obtains the transmission right on the link corresponding to the wireless signal processing unit 150, the internal collision management unit 154 prevents collision in data transmission. That is, the internal collision management unit 154 adjusts the transmission timing of each of a plurality of pieces of data for which the transmission right has been obtained in STA1, and outputs the data of the access category with high priority in order to STA1.

In addition, in the functional configuration illustrated FIG. 5, a trigger frame TF or an instruction to generate the trigger frame TF is input from the trigger generation unit 134 to the MAC frame processing unit 140 when the rTWT function is used. At this time, the management unit 110 including the MAC frame processing unit 140 checks the situation of each of all the links of the link set LS by causing each channel access function of the wireless signal processing units 150, 160, and 170 to perform carrier sensing or the like. In a case where all the links (channels) of the link set LS are in a busy state, the management unit 110 continues checking of the situation until one or more links are in an idle state. When one or more links (channels) of the link set LS are in an idle state and the transmission right is obtained on the one of more links, the management unit 110 causes the wireless signal processing unit (corresponding one or more of 150, 160, and 170) corresponding the link that has obtained the transmission right to transmit the trigger signal obtained by converting the trigger frame TF to the terminal 20.

As 11 ted in FIG. 8, in the channel access function of the wireless signal processing unit 150, the classification unit 151 inputs the input trigger frame TF or generation instruction to the internal collision management unit 154 without passing through any of the queues 152A to 152D. Therefore, for the trigger frame TF, the processing of obtaining the transmission right and the like are performed with lower latency than other traffic. When the rTWT function is used, the channel access function obtains the transmission right for the trigger frame TF in a state where the trigger signal is transmitted at the start of the rTWT-SP (rTWT start time) set as the specified period.

In one example, when the rTWT function is used, when the trigger frame TF is input to the channel access function of the wireless signal processing unit 150, the channel access function performs carrier sensing or the like on the trigger frame TF by using the trigger frame TF as data having the highest transmission priority. In this case, the channel access function obtains the transmission right of the trigger frame TF, for example, by using an access category with the highest priority of enhanced distributed channel access (EDCA) or by preferential transmission procedure different from EDCA, and causes the AP 10 to transmit the trigger signal at the start of the rTWT-SP. In addition, in another example, by temporarily stopping the carrier sensing of the carrier sensing execution units 153A to 153D, the transmission of the data frames of VO, VI, BE, and BK is temporarily stopped, and the transmission of the trigger frame TF is prioritized.

In the functional configuration illustrated in FIG. 5, as described above, the carrier sensing by each channel access function of the wireless signal processing units 150, 160, and 170 is performed in response to an input of the trigger frame TF or the like to the MAC frame processing unit 140. At this time, om a case where a plurality of links (channels) constituting the link set LS is in an idle state, the MAC frame processing unit 140 causes the trigger signal to be transmitted to terminal 20 through each of the plurality of links in the idle state. In a case where the trigger signal is transmitted from a plurality of the wireless signal processing units 150, 160, and 170, the MAC frame processing unit 140 performs redundancy processing of the trigger frame TF by duplicating the trigger frame TF or the like. A plurality of trigger frames TF common to each other is generated by the redundancy processing. The MAC frame processing unit 140 outputs the trigger frames TF subjected to the redundancy processing one by one to each of the plurality of links in the idle state in the link set LS. Then, the trigger signal is transmitted to the terminal 20 as the first wireless signal redundantly transmitted to the plurality of links.

In addition, in a case where the trigger signal is redundantly transmitted, the MAC frame processing unit 140 notifies each of the wireless signal processing units (corresponding two or more of 150, 160, and 170) that transmit the trigger signal of the time information generated by the communication management unit 130. Then, the wireless signal processing units (corresponding two or more of 150, 160, and 170 notified of the time information cooperate with each other to transmit the trigger signal to the terminal 20 in parallel (in synchronization) with each other by plurality of links of the link set LS. In one example, each of the wireless signal processing units (corresponding two or more of 150, 160, and 170) that transmit the trigger signal is notified of the rTWT start time based on the time information from the communication management unit 130. Then, wireless signal processing units (corresponding two or more 150, 160, and 170) notified of the rTWT start time generate the trigger frame TF in a state transmitting the trigger signal in parallel with each other at the start of the rTWT-SP.

In addition, the plurality of trigger frames TF subjected to the redundancy processing does not need to be completely the same with respect to each other. In one example, in the redundancy processing, each trigger frame TF is customized to a state having unique information for the link for transmitting the trigger signal. In another example, only information common to the plurality of links is duplicated in the redundancy processing. Then, the trigger frame TF is generated by each of the links for transmitting the trigger signal, that is, the corresponding plurality of STA1 to STA3 by using information common to each other in the plurality of links. In addition, the target for which the redundancy processing performed is not limited to the trigger frame TF, and for example, the redundancy processing may be similarly performed on the beacon frame.

In the functional configurations illustrated in FIGS. 5 and 6, when the wireless signal processing unit 250 of the terminal 20 receives the trigger signal from the AP 10, the trigger frame TF is input from the MAC frame processing unit 240 to the communication management unit 230. The communication management unit 230 recognizes that an instruction to transmit uplink data requiring low latency during the rTWT-SP is received from the AP 10 by the input trigger frame TF. In addition, the communication management unit 230 recognizes a resource allocated for transmission of uplink data requiring low latency in the rTWT-SP by the trigger frame TF.

In addition, in a case where the trigger signal is transmitted through each of the plurality of links of the link set LS, the wireless signal processing unit 250 of the terminal 20 may receive the trigger signal from each of the plurality of links (plurality of channels). In this case, when the trigger frame TF is input from each of the plurality of links, the MAC frame processing unit 240 may perform duplication check of checking information duplicate with each other for the plurality of input trigger frames TF. In the case of performing the duplication checking, the MAC frame processing unit 240 leaves only the information of one trigger frame TF and discards the information of the other trigger frames for the information duplicate with each other for the plurality of trigger frames TF.

When the trigger frame is input from the MAC frame processing unit 240, the communication management unit 230 determines a link for transmitting the uplink data requiring low latency in the rTWT-SP from the links of the link set LS. When the trigger signal is received from the AP 10 through only one link, the communication management unit 230 sets the link that has received the trigger signal as a link transmitting the uplink data. Then, the management unit 210 including the communication management unit 230 causes the wireless signal processing unit 250 to transmit the wireless signal of the uplink data requiring low latency through the link that has received the trigger signal, and causes wireless communication with the AP 10 by using the link that has received the trigger signal until the end of the rTWT-SP that is the specified period.

When the trigger signal is received from the AP 10 through each of the plurality of links, the communication management unit 230 selects one of the plurality of links that have received the trigger signal as a link for transmitting the uplink data. Then, the management unit 210 including the communication management unit 230 causes the wireless signal processing unit to transmit the wireless signal of the uplink requiring low latency as the second wireless signal through the selected one of the plurality of links that have received the trigger signal. Then, the communication management unit 230 causes wireless communication with the AP 10 by using the selected one of the plurality of links that have received the trigger signal until the end of the rTWT-SP that is the specified period.

A method of selecting one to be used for transmission of uplink data from the plurality of links that have received the trigger signal is not particularly limited. In one example, the communication management unit 230 specifies a resource having the earliest transmission timing from the resources for transmission of the uplink data allocated in the trigger frame TF. Then, the communication management unit 230 selects the link corresponding to the resource specified as the resource having the earliest transmission timing as the link used for the transmission of the uplink data, that is, the link used for the wireless communication with the AP 10 in the rTWT-SP. In another example, a link (channel) having the least interference the links that have received the trigger signal is selected as a link to be used for transmission of uplink data.

Since the link used by the terminal 20 for wireless communication with the AP 10 in the rTWT-SP is set as described above, when the rTWT function is used, one link used by the terminal 20 for wireless communication with the AP 10 is determined from the links constituting the link set LS every rTWT-SP. Therefore, a link different from the link used by the terminal 20 for wireless communication with the AP 10 in the previous rTWT-SP can be selected as the link used by the terminal 20 for the wireless communication with the AP 10 in a real-time rTWT-SP.

The MAC frame processing unit 240 inputs a data frame of traffic for which low latency is required to the wireless signal processing unit 250 together with information indicating a link used for transmission of uplink data in the rTWT-SP. Then, the wireless signal processing unit 250 transmits the wireless signal of the uplink data for which low latency is required to the AP 10 through the link set as the link used for transmission of uplink data. In one example, in response to the input of the trigger frame TF to the MAC frame processing unit 240, the MAC frame processing unit 240 of the management unit 210 inputs a data frame requiring low latency to the wireless signal processing unit 250. Then, the wireless signal processing unit 250 converts the input data frame into a wireless signal and transmits the wireless signal to the AP 10.

In another example, the MAC frame processing unit 240 acquires the rTWT start time that is the start time of the rTWT-SP on the basis of the information included in the beacon frame described above. The, the MAC frame processing unit 240 inputs the data frame requiring low latency to the wireless signal processing unit 250 together with the time information indicating the rTWT start time before the start of the rTWT-SP. Then, in response to the reception of the trigger signal, the wireless signal processing unit 250 converts the data frame input from the MAC frame processing unit 240 into a wireless signal and transmits the converted wireless signal to the AP 10.

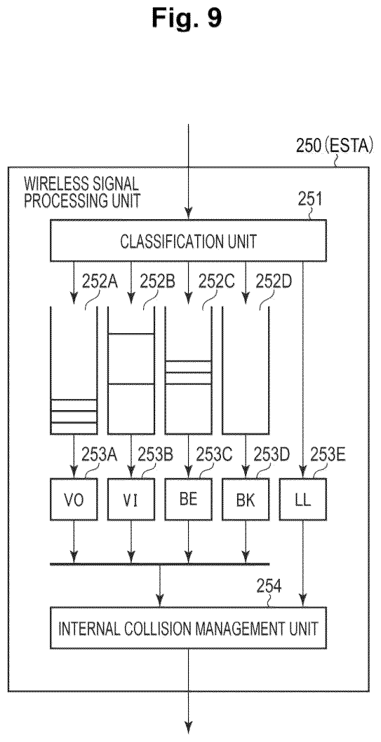

FIG. 9 is a block diagram illustrating an example of a functional configuration channel access function of the terminal 20, which is an SR terminal, according to the embodiment. In the example of FIG. 9, one channel access function is provided in the wireless signal processing unit 250, and the channel access function checks the situation of one that transmits the data among the plurality of links constituting the link set LS. Note that, in one example, the channel access function is provided in the MAC frame processing unit 240 instead of the wireless signal processing unit 250. In addition, in a other example, the same number of channel access functions as the links constituting the link set LS are provided in the wireless signal processing unit 250, and one channel access function is provided for each of the plurality of links of the link set LS. Then, each of the plurality of channel access functions checks a situation of corresponding one of the links of the link set LS. As illustrated in FIG. 9, the channel access function includes, for example, a classification unit 251, queues 252A, 252B, 252C, and 252D, carrier sensing execution units 253A, 253B, 253C, 253D, and 253E, and an internal collision management unit 254.

The basic operation of the classification unit 251 is similar to that of the classification unit 151 of the AP 10, and the basic functions of the queues 252A, 252B, 252C, and 252D are similar to those of the queues 152A, 152B, 152C, and 152D of the AP 10, respectively. In addition, the basic operations of the carrier sense execution units 253A, 253B, 253C, and 253D are similar to those of the carrier sensing execution units 153A, 153B, 153C, and 153D of the AP 10, respectively, and the basic operation of the internal collision management unit 254 is similar to that of the internal collision management unit 154 of the AP 10.

Here a data frame requiring low latency the access category of which is LL is input to the channel access function of the wireless signal processing unit 250 of the terminal 20. The channel access function transmits uplink data the access category of which is LL by using the rTWT function. By using the rTWT function, uplink data the access category of which is LL is preferentially transmitted from the terminal 20 to the AP 10 during the rTWT-SP. In the rTWT-SP in which transmission of uplink data the access category of which is LL prioritized, transmission of uplink data the access category of which is other than LL is suppressed. In the channel access function of the example of FIG. 9, the classification unit 251 inputs the data frame the access category of which is LL to the carrier sensing execution unit 263E without passing through any of the queues 252A to 252D.

In addition, in the channel access function of the terminal 20, in addition to the carrier sensing execution units 253A to 253D, the carrier sensing execution unit 253E also executes carrier sensing according to access parameters set in advance. The carrier sensing execution unit 253E performs carrier sensing on the uplink data the access category of which is LL. In the channel access function of the terminal 20, for example, the above-described access parameters are set in a state where the transmission of the wireless signal is prioritized in the order of LL, VO, VI, BE, and BK. Accordingly, in the channel access function of the terminal 20, particularly in the rTWT-SP, for the traffic the access category of which is LL, processing for obtaining the transmission right and the like are performed with low latency as compared with other traffic. In one example, by temporarily stopping the carrier sensing of the carrier sensing execution units 253A to 283D, the transmission of the traffic of the access category other than LL is temporarily stopped, and the transmission of the traffic of the access category of LL is prioritized.

In the functional configurations of FIGS. 5 and 6, when the rTWT function is used, when the trigger signal (first wireless signal) is transmitted from each of the plurality of wireless signal processing units (two or more of 150, 160, and 170) of the AP 10 to the terminal 20, the management unit 210 of the terminal 20 transmits the wireless signal (second wireless signal) of the uplink data to the AP 10 through one of the plurality of links that have received the trigger signal. Therefore, the AP 10 receives the wireless signal of the uplink data transmitted from the terminal 20 in response to the trigger signal by the corresponding one of the plurality of links that have transmitted the trigger signal. That is, in the AP 10, corresponding one of the wireless signal processing units 150, 160, and 170 (STA1 to STA3 receives the wireless signal of the uplink data.

When the AP 10 receives the uplink data corresponding to the trigger signal, the management unit 110 (communication management unit 130) causes wireless communication with the terminal 20 by one of the wireless signal processing units 150, 160, and 170 (STA1 to STA3) that has received the uplink data (second wireless signal) until the end of the rTWT-SP that is the specified period. Accordingly, until the end of the rTWT-SP, the AP 10 wirelessly communicates with the terminal 20 through only one of the links of the link set LS that has received the uplink data (second wireless signal).

For example, in the rTWT-SP, downlink data may be transmitted from the AP 10 to the terminal 20 subsequent to the uplink data received from the terminal 20. In this case, the MAC frame processing unit 140 inputs the data frame of the downlink the wireless signal processing unit (corresponding one of 150, 160, and 170) that has received the uplink data. Then, the management unit 110 transmits the wireless signal of the downlink data to the terminal 20 from the wireless signal processing unit (corresponding one of 150, 160, and 170) that has received the uplink data, that is, through one of the links of the link set LS that has received the uplink data.

In addition, in a case where the trigger signal is transmitted through each of the plurality of links, the management unit 110 (communication management unit 130) releases, from the wireless communication with the terminal 20, the links other than the one that has received the uplink data from the terminal 20 among the plurality of links that have transmitted the trigger signal. That is, the wireless signal processing units (corresponding one or more of 150, 160, and 170) that have not received the uplink data from the terminal 20 after transmitting the trigger signal are released from the resource for the wireless communication with the terminal 20 in the rTWT-SP. The management unit 110 notifies the wireless signal processing units (corresponding one or more of 150, 160, and 170) that have not received the uplink data from the terminal 20 after transmitting the trigger signal of the release from the resource for the wireless communication with the terminal 20.

In one example, the link (channel) released from the resource for the wireless communication with terminal 20 is newly allocated as resource for wireless communication of the AP 10 with terminals other than terminal 20 until the end of the rTWT-SP. In this case, the MAC frame processing unit 140 inputs, for example, a trigger frame indicating a new allocation as a resource for the links released from the wireless communication with the terminal 20 to the wireless signal processing units (corresponding one or more of 150, 160, and 170) released from the wireless communication with the terminal 20. As a result, the link (channel) released from the wireless communication with the terminal 20 is newly allocated as a resource for the wireless communication with terminals other than the terminal 20.

Note that it is not always necessary for the management unit 110 to newly allocate, as a resource, the links released from the wireless communication with the terminal 20. In one example, the wireless signal processing units (correspond) one or more of 150, 160, and 170) released from the wireless communication with the terminal 20 determine a new allocation of the corresponding links (channels) as a resource.

In addition, in the rTWT-SP, in the link used for the wireless communication with the terminal 20 and the link released from the wireless communication with the terminal 20, the frequencies of allocated channels may be so close to each other that power leakage occurs. That is, in the rTWT-SP, the link used for the wireless communication with terminal 20 and the link released from the wireless communication with the terminal 20 may have a non-simultaneous transmit and receive (NSTR) relationship with each other. In this case, the link (channel) released from the wireless communication with the terminal 20 is preferably newly allocated as a resource to a state not used for transmission of data from the AP 10 to a terminal other than the terminal 20 or the like.

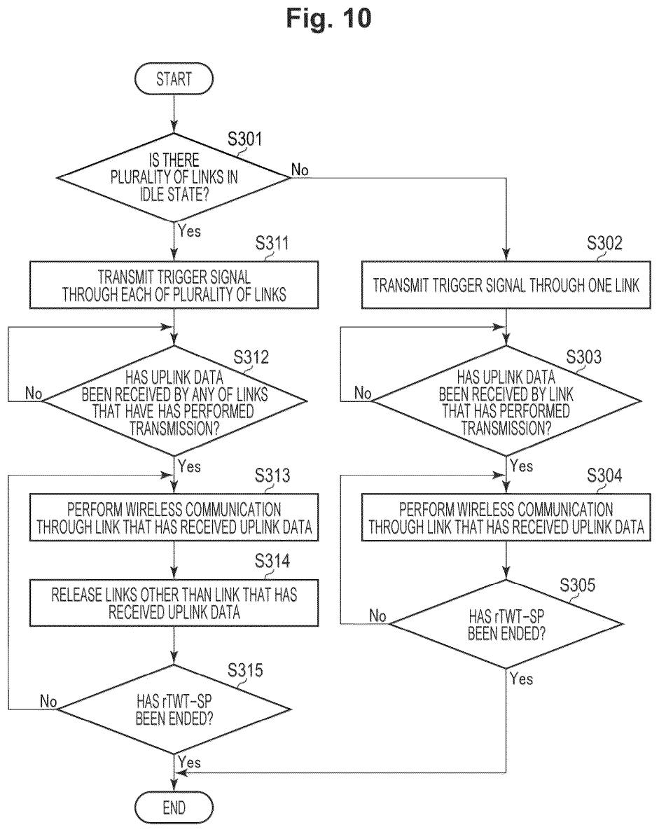

FIG. 10 is a flowchart illustrating an example of processing performed by the management unit 110 of the AP 10 according to the embodiment when the rTWT function is used. The processing of the example of FIG. 10 is performed to cause the terminal 20 to transmit the uplink data requiring low latency every rTWT-SP. In addition, in a case where the processing of the example of FIG. 10 is performed, it is assumed that immediately before the rTWT-SP, one or more links of the link set LS are in an idle state, and the AP 10 can transmit a wireless signal to the terminal 20 through one or more links of the link set LS. When the processing of the example of FIG. 10 is started, the management unit 110 determines whether or not there is a plurality of links (channels) in the idle state in the link set LS (S301).

In a case where only one link is in the idle state (S301—No), the management unit 110 causes the above-described trigger signal to be transmitted to the terminal 20 through one link in the idle state, that is, from the wireless signal processing unit (corresponding one of 150, 160, and 170) corresponding to the one link in the idle state (S302). Then, the management unit 110 determines whether or not the uplink data from the terminal 20 has received by the link that has transmitted the trigger signal (S303). The processing waits in S303 until the uplink data from the terminal 20 is received.

Then, when the uplink data from the terminal 20 is received (S303—Yes), the management unit 110 causes wireless communication with terminal 20 through the link that has received the uplink data (S304). Therefore, the management unit 110 causes the downlink data or the like subsequent to the uplink data to be transmitted to the terminal 20 through the link that has received the uplink data. Then, the management unit 110 determines whether the rTWT-SP has ended (S305). As long as the rTWT-SP is not ended (S305—No), the processing returns to S304, and the management unit 110 causes wireless communication with the terminal 20 through the link that has received the uplink data.

In addition, in a case where a plurality of links is in the idle state in S301 (S301—Yes), the management unit 110 causes the above-described trigger signal (first wireless signal) to be transmitted to the terminal 20 through each of the plurality of links in the idle state, that is, from each of the wireless signal processing units (corresponding two or more of 150, 160, and 170) corresponding to the plurality of links in the idle state (S311). At this time, the trigger signal is transmitted to the terminal 20 in parallel with each other by the plurality of links. Then, the management unit 110 determines whether or not the uplink data from the terminal 20 has been received by any of the plurality of links that have transmitted the trigger signal (S312). The processing waits in S312 until the uplink data from the terminal 20 is received by any one of the plurality of links.

Then, when the uplink data from the terminal 20 is received by one of the plurality of links that have transmitted trigger signal (S312—Yes), the management unit 110 causes wireless communication with the terminal 20 through the link that has received the uplink data (S313). Therefore, the management unit 110 causes the downlink data or the like subsequent to the uplink data to be transmitted to the terminal 20 through the one of the plurality of links that has received the uplink data. In addition, the management unit 110 releases, from the wireless communication terminal 20, links other than the one link that has received the uplink data among the plurality of links that have transmitted the trigger signal (S314). At this time, the links released from the wireless communication with the terminal 20 may be allocated as a resource used for the wireless communication between a terminal other than the terminal 20 and the AP 10.

Then, the management unit 110 judges whether the rTWT-SP has ended (S315). As long as rTWT-SP is not ended (S315—No), the processing returns to S313. Therefore until the end of the rTWT-SP, the management unit 110 causes the wireless communication with the terminal 20 through the link that received the uplink data, and releases the links other than the link that has received the uplink data from the wireless communication with the terminal 20.

Note that, in one example, the trigger signal is transmitted to the terminal 20 through each of the plurality of links of the link set LS at the start of the rTWT-SP, and the trigger signal is not transmitted through only one link. In this case, the processing of S302 to S305 is not performed, and the processing of S311 to S315 is sequentially performed every rTWT-SP.

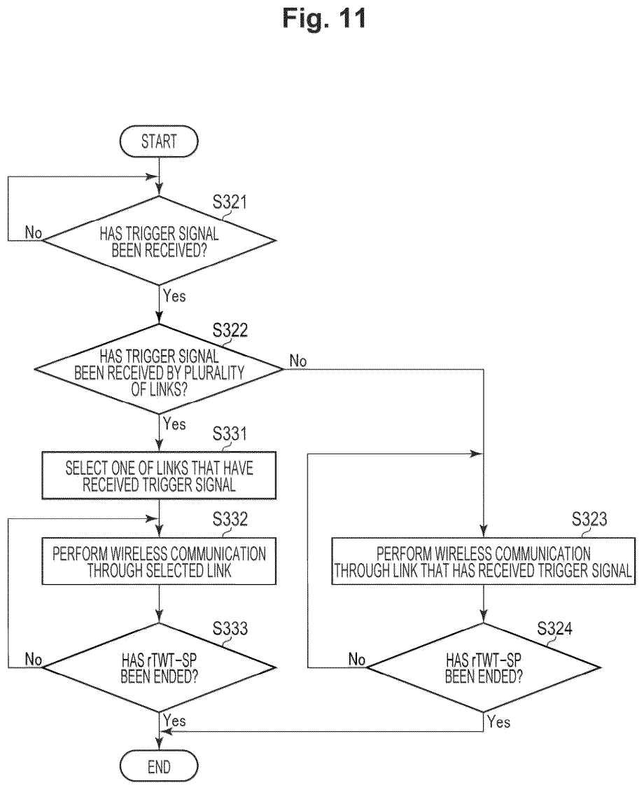

FIG. 11 is a flowchart illustrating an example of processing performed by the management unit 210 of the terminal 20 according to the embodiment when the rTWT function is used. The processing of the example of FIG. 11 is performed to transmit the uplink data requiring low latency to the AP 10 every rTWT-SP. In addition, in a case where the processing of the example of FIG. 11 is performed, it is assumed that the trigger signal is transmitted from the AP 10 to the terminal 20 by the processing illustrated in the example of FIG. 10 or the like. When the processing of the example of FIG. 11 is started, the management unit 210 determines whether or not the trigger signal from the AP 10 is received by any link (S321). The processing waits in S321 until the trigger signal is received by any of the links. Then, when the trigger signal is received (S321—Yes), the management unit 210 determines whether the trigger signal has been received by the plurality of links of the link set LS (S322).

In a case where the trigger signal has been received by only one link (S322—No), the management unit 210 causes wireless communication with the AP 10 through the one link that has received the trigger signal (S323). Therefore, the management unit 210 causes the uplink data or the like requiring low latency to be transmitted to the AP 10 through the link that has received the trigger signal.

Then, the management unit 210 determines whether the rTWT-SP has ended (S324). As long as the rTWT-SP is not ended (S324—No), the processing returns to S323, and the management unit 210 causes wireless communication with the AP 10 through the link that has received the trigger signal.

In addition, in a case where the trigger signal has been received by the plurality of links in S322 (S322—Yes), the management unit 210 selects one of the links that have received the trigger signal to transmit the uplink data or the like requiring low latency (S331). At this time, one link is selected in the same manner as any of the methods described above. Then, the management unit 210 causes wireless communication with the AP 10 through the selected one link (S332). Therefore, the management unit 210 causes the uplink data or the like requiring low latency to be transmitted to the AP 10 through the one of the links that has received the trigger signal. Then, the management unit 210 determines whether the rTWT-SP has ended (S333). As long as the rTWT-SP is not ended (S333—No), the processing returns to S332, and the management unit 210 causes wireless communication with the AP 10 through the selected link.

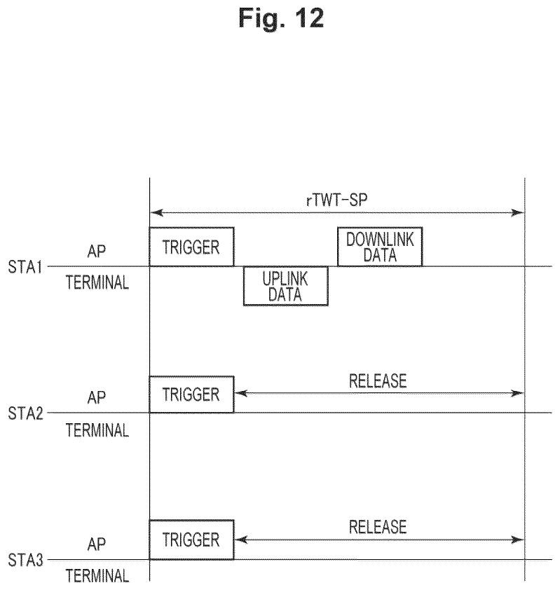

FIG. 12 is a schematic diagram illustrating temporal changes in a communication state through a link set between the AP 10 and the terminal 20 in the communication system 1 according to the embodiment. In FIG. 12, it is assumed that three STA functions STA1, STA2, and STA3 of the AP 10 form links with link IDs of “STA1”, “STA2”, and “STA3” in the link set LS, respectively, with respect to the ESTA function of the terminal 20. In the example of FIG. 12, the management unit 110 of the AP 10 causes the trigger signal to be transmitted from the AP 10 to the terminal 20 through each of the three links of “STA1”, “STA2”,and “STA3” at the start of the rTWT-SP.

Then, the management unit 210 selects the link “STA1” from the three links that have received the trigger signal as a link for transmitting the uplink data in the rTWT-SP. Then, the management unit 210 causes the uplink data to be transmitted through the selected link “STA1”. Then, when the AP 10 receives the uplink data by the link “STA1”, the management unit 210 causes the subsequent downlink data to be transmitted to the terminal 20 through the link “STA1”. Accordingly, until the end of the rTWT-SP, the AP 10 and the terminal wirelessly communicate with each other through the link “STA1”. In addition, in the example of FIG. 12, the management unit 110 releases each of the Links “STA2” and “STA3” that have not been selected as the links for transmitting the uplink data from the wireless communication with the terminal 20.

As described above, in the present embodiment, the management unit 110 of the AP 10 transmits the trigger signal serving as the first wireless signal from each of the plurality of wireless signal processing units (corresponding two or more of 150, 160, and 170) to the terminal 20. Then, the management unit 210 of the terminal 20 transmits the wireless signal of the uplink data to the AP 10 as the second wireless signal through one of the plurality of links that have received the trigger signal. Then, the AP 10 and the terminal 20 perform wireless communication with each other through the one link that has transmitted the uplink data from the terminal 20 until the end of the rTWT-SP that is the specified period.

Since the wireless communication in the rTWT-SP is performed as described above, even if a failure occurs in the wireless communication between the AP 10 and the terminal 20 through one of the plurality of links, the management unit 210 can transmit the uplink data to the AP 10 through another one of the plurality of links that have received the trigger signal. For example, when the trigger signal is transmitted to the terminal 20 through each of the three links of “STA1”, “STA2”, and “STA3”, even if a failure occurs in the wireless communication through the link “STA1”, one of “STA2” and “STA3” can be selected as the link for transmitting the uplink data.

Accordingly, in the present embodiment, even in a case where the uplink data is transmitted from a terminal provided with only one STA function such as the terminal 20 to the AP, redundancy is appropriately performed. That is, even the terminal that cannot transmit the data in parallel through the plurality of links can secure reliability in transmission of the uplink data to the AP 10 and secure reliability in data exchange between the terminal 20 and the AP 10.

In addition, in the present embodiment, the link (channel) that has not been selected as the link for transmitting the uplink data among the links used for transmitting the trigger signal is released from the wireless communication with the terminal 20 by the management unit 110. Therefore, the link (channel) not used for transmitting the uplink data in the rTWT-SP can also be effectively utilized by being used for the wireless communication between a terminal other than the terminal 20 and the AP 10.

Note that, in the following modification, the management unit 210 selects a link used for transmission of the uplink data in the rTWT-SP among the links of the link set LS before the start of the rTWT-SP. In the present modification, when the rTWT function is used, before the rTWT-SP that is the specified period is started, the management unit 110 of the AP 10 causes a request to send (RTS) signal to be transmitted as the first wireless signal. At this time, the RTS signal is transmitted to the terminal 20 through each of the plurality of links of the link set LS, and is transmitted from a plurality of wireless signal processing units (corresponding two or more of 150, 160, and 170) in parallel (in synchronization) with each other. By the RTS signal, a terminal 20 other than the terminal 20 is notified that the AP 10 is scheduled to wirelessly communicate with the terminal 20 in the rTWT-SP.

In the present modification, when the terminal 20 receives the RTS signal through each of the plurality of links, the management unit 210 selects one of the plurality of links that have received the RTS signal. Then, before the rTWT-SP is started, the management unit 210 causes a clear to send (CTS) signal to be transmitted to the AP 10 as the second wireless signal through the selected one link. At this time, the CTS signal is not transmitted from the terminal 20 to the AP 10 except for the link that has transmitted the CTS signal among the links used for transmitting the RTS signal. A terminal 20 other than the terminal 20 is notified by the CTS signal of the use of the link (channel) that has transmitted the CTS signal for the wireless communication between the AP 10 and the terminal 20 in the rTWT-SP.

In the present modification, the AP 10 receives the CTS signal through the corresponding one of the links that have transmitted the RTS signal, that is, the corresponding one of the wireless signal processing units 150, 160, and 170. Then, at the start of the rTWT-SP, the management unit 110 causes the above-described trigger signal to be transmitted to the terminal 20 through one that has received the CTS signal among the links that have transmitted the RTS signal. As a result, the terminal 20 receives the trigger signal through the link that has transmitted the CTS signal. Then, during the rTWT-SP that is the specified period, the AP 10 and the terminal 20 wirelessly communicate with each other through the one link used for transmission of the CTS signal. In addition, the management unit 110 releases, from the wireless communication with the terminal 20, links other than the one that has received the CTS signal among the links that have transmitted the RTS signal until the end of the rTWT-SP.

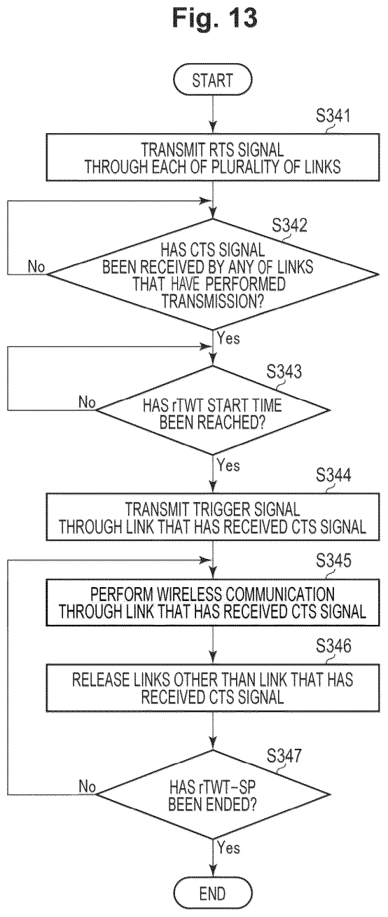

FIG. 13 is a flowchart illustrating an example of processing performed by the management unit 110 of the AP 10 according to modification when the rTWT function is used. The processing of the example of FIG. 13 is performed to cause the terminal 20 to transmit the uplink data requiring low latency every rTWT-SP. In addition, in a case where the processing of the example of FIG. 13 is performed, it is assumed that the wireless signal can be transmitted from the AP 10 to the terminal 20 through each of the plurality of links of the link set LS immediately before the rTWT-SP. When the processing of the example of FIG. 13 is started, the management unit 110 causes the RTS signal to be transmitted as the first wireless signal to the terminal 20 through each of the plurality of links of the link set LS (S341). Then, the management unit 110 determines whether or not the CTS signal from the terminal 20 has been received by any of the plurality of links that have transmitted the RTS signal (S342). The processing waits in S342 until the CTS signal from the terminal 20 is received by any one of the plurality of links.

Then, when the CTS signal from the terminal 20 is received by any one of the plurality of links that have transmitted the RTS signal (S342—Yes), the management unit 110 waits until the rTWT start time (start of the rTWT-SP) (S343—No). Then, upon the rTWT start time (S343—Yes), the management unit 110 causes the trigger signal to be transmitted to the terminal 20 through the link that has received the CTS signal (S344). Then, the management unit 110 causes the wireless communication with the terminal 20 through the link that has received the CTS signal (S345). In addition, the management unit 110 releases, from the wireless communication with the terminal 20, links other than the one link that has received the CTS signal among the plurality of links that have transmitted the RTS signal (S346).

Then, the management unit 110 judges whether the rTWT-SP has ended (S347). As long as the rTWT-SP is not ended (S347—No), the processing returns to S345. Therefore until the end of the rTWT-SP, the management unit 110 causes the wireless communication with the terminal 20 through the link that has received the CTS signal, and releases the links other than the link that has received the CTS signal from the wireless communication with the terminal 20.

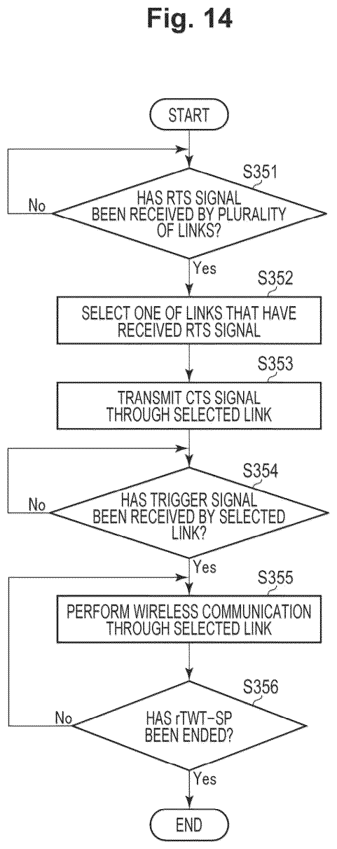

FIG. 14 is a flowchart illustrating example of processing performed by the management unit 210 of the terminal 20 according to the modification of FIG. 13 when the rTWT function is used. The processing of the example of FIG. 14 is performed to transmit the uplink data requiring low latency to the AP 10 every rTWT-SP. In addition, in a case where the processing the example of FIG. 14 is performed, it is assumed that the RTS signal is transmitted through each of the plurality of links from the AP 10 to the terminal 20 by the processing illustrated in the example of FIG. 13 or the like. When the processing of the example of FIG. 14 is started, the management unit 210 determines whether the RTS signal transmitted from the AP 10 is received by each of the plurality of links (S351). The processing waits in S351 until the plurality of links receives the RTS signal.

When the RTS signal has been received by the plurality of links (S351—Yes), the management unit 210 selects one that is used to transmit the uplink data requiring low latency among the links that have received the RTS signal (S352) Then, the management unit 210 causes the CTS signal to be transmitted to the AP 10 through the selected one link (S353). Then, the management unit 210 waits until the trigger signal from the AP 10 is received by the one link that has transmitted the CTS signal, which is the selected link (S354—No).

When the trigger signal is received by the link that has transmitted the CTS signal (S354—Yes), the management unit 210 causes the wireless communication with the AP 10 through the one link that has received the trigger signal, which is the selected link (S355). Then, long as the rTWT-SP is not ended (S356—No), the processing returns to S355, and the management unit 210 causes wireless communication with the AP 10 through the selected link.

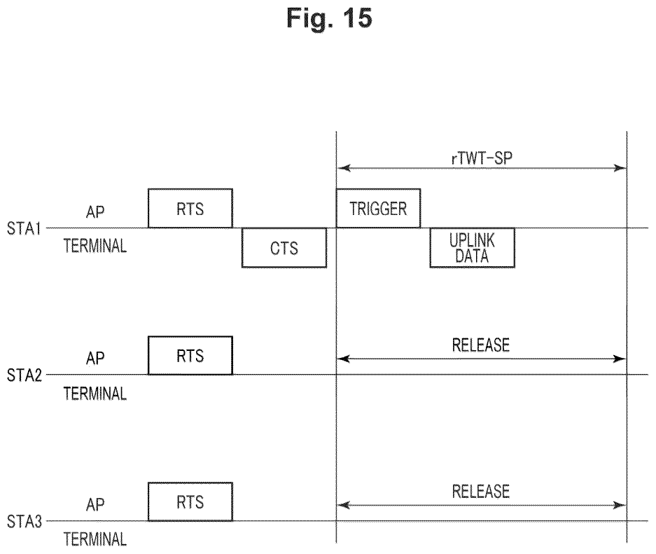

FIG. 15 is a schematic diagram illustrating temporal changes in a communication state through link set between the AP 10 and the terminal 20 in the communication system 1 according to the modification. In the example of FIG. 15, the management unit 110 of the AP 10 causes the RTS signal to be transmitted from the AP 10 to the terminal 20 through each of the three links of “STA1”, “STA3”, and “STA3” before the start of the rTWT-SP. Then, the management unit 210 selects the link “STA1” from the three links that have received the RTS signal as a link for transmitting the uplink data in the rTWT-SP. Then, the management unit 210 causes the CTS signal to be transmitted through the selected link “STA1”.

Then, when the AP 10 receives the CTS signal by the link “STA1”, the management unit 110 causes the trigger signal to be transmitted to the terminal 20 through the link “STA1” at the start of the rTWT-SP. As a result, from the start to the end of the rTWT-SP,, the AP 10 and the terminal wirelessly communicate with each other through the link “STA1”. Therefore, in the rTWT-SP, the uplink data to the AP 10 is transmitted through the link “STA1”. In addition, in the example of FIG. 15, the management unit 110 releases each of the links “STA2” and “STA3” that have not been selected as the links for transmitting the uplink data from the wireless communication with the terminal 20.

Also in the modification, the same operations and effects as those of the above-described embodiment and the like are obtained. That is, even in the modification, in the terminal provided with only one STA function such as the terminal 20, it is possible to secure reliability in transmission of uplink data to the AP 10, and it is possible to secure reliability in data exchange between the terminal 20 and the AP 10. In addition, also in the modification, it is possible to effectively utilize a link (channel) that is not used for transmission of uplink data in the rTWT-SP.

In addition, in the modification, before the trigger signal is transmitted to the terminal 20, a link used for transmission of the uplink data from the terminal 20 to the AP 10 in rTWT-SP that is the specified period is determined. Therefore it is not necessary to newly allocate a link (channel) released from wireless communication with the terminal 20 in the rTWT-SP as a resource after the start of the rTWT-SP, that is, after the transmission of the trigger signal.

Note that, in the embodiment and the modification described above, the case where the AP 10 wirelessly communicates with the terminal 20 using the three STA functions, and the link set LS between the AP 10 and the terminal 20 includes the three links has been described, but the embodiment and the modification are not limited thereto. In the embodiment and the like, when the AP 10 wirelessly communicates with the terminal 20 using a plurality of STA functions and the link set LS between the AP 10 and the terminal 20 includes a plurality of links, the above-described functions can be and the above-described processing can be executed.

In addition, the processing according to the embodiment and modification described above can be stored as a program that can be executed by a processor that is a computer. In addition, it is possible store and distribute a program that executes the above-described processing in a storage medium of an external storage device such as a magnetic disk, optical disk, or a semiconductor memory. Then, the processor reads the program stored in the storage medium of the external storage device, and the operation is controlled by the read program, whereby the processing of the embodiment and the like can be executed.

Note that the present invention is not limited to the above embodiments, and various modifications can be made in the implementation stage without departing from the gist of the invention. In addition, the embodiments may be implemented in appropriate combination, and in this case, a combined effect can be obtained. Furthermore, the above embodiment include various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

### REFERENCE SIGNS LIST

1 Communication system
10 Access point (AP)
20 Terminal
30 Network
11, 21 CPU
12, 22 ROM
13, 23 RAM
14, 24 Wireless communication module
15: Wired communication module
25 Display
26 Storage
100, 200 LLC processing unit
110, 210 Management unit
120, 220 Data processing unit
130, 230 Communication management unit
131, 231 Link management information
132, 232 Link control unit
133, 233 Beacon management unit
134 Trigger generation unit
140, 240 MAC frame processing unit
150, 160, 170, 250 Wireless signal processing unit
151, 251 Classification unit
152A to 152D, 252A to 252D Queue
153A to 153D, 253A to 2538 Carrier sensing execution unit
154, 254 Internal collision management unit
280 Application execution unit

1. An access point comprising:
a plurality of wireless signal processing units; and
a management unit that establishes a plurality of links with a terminal by using the plurality of wireless signal processing units and causes each of the plurality of wireless signal processing units to transmit a first wireless signal to the terminal, the management unit causing wireless communication with the terminal until an end of a specified period by one of the plurality of wireless signal processing units that has received a second wireless signal on a basis of reception of the second wireless signal transmitted from the terminal in response to transmission of the first wireless signal by the one of the plurality of wireless signal processing units.

2. The access point according to claim 1, wherein
the management unit causes each of the plurality of wireless signal processing units to transmit a trigger signal giving an instruction on transmission of uplink data as the first wireless signal at start of the specified period, and
the one of the plurality of wireless signal processing units receives uplink data transmitted from the terminal in response to the trigger signal as the second wireless signal in the specified period.

3. The access point according to claim 1, wherein
the management unit causes each of the plurality of wireless signal processing units to transmit an RTS signal or a MU-RTS signal as the first wireless signal before start of the specified period,
the one of the plurality of wireless signal processing units receives a CTS signal transmitted from the terminal in response to the RTS signal or the MU-RTS signal as the second wireless signal before start of the specified period, and
the management unit causes, at start of the specified period, the one of the plurality of wireless signal processing units that has received the CTS signal to transmit a trigger signal giving an instruction on transmission of uplink data to the terminal.

4. The access point according to claim 1, wherein from reception of the second wireless signal by the one of the plurality of wireless signal processing units to the end of the specified period, the management unit releases wireless signal processing units other than the one that has received the second wireless signal among the plurality of wireless signal processing units from the wireless communication with the terminal.

5. A terminal comprising:
a wireless signal processing unit; and
a management unit that establishes a plurality of links with an access point by using the wireless signal processing unit and causes the wireless signal processing unit to transmit a second wireless signal through one of the plurality of links on a basis of reception of a first wireless signal transmitted from the access point through each of the plurality of link by the wireless signal processing unit, the management unit causing wireless communication with the access point until an end of a specified period from transmission of the second wireless signal by using the one of the plurality of links that has transmitted the second wireless signal.

6. The terminal according to claim 5, wherein
the wireless signal processing unit receives, as the first wireless signal, a trigger signal that is transmitted from the access point through each of the plurality of links at start of the specified period and gives an instruction on transmission of uplink data, and
management unit causes the wireless signal processing unit to transmit uplink data as the second wireless signal to the access point through the one of the plurality of links in response to reception of the trigger signal by the wireless signal processing unit in the specified period.

7. The terminal according to claim 5, wherein
wireless signal processing unit receives an RTS signal or a MU-RTS signal transmitted from the access point through each of the plurality of links as the first wireless signal before start of the specified period,
the management unit causes the wireless signal processing unit to transmit a CTS signal as the second wireless signal to the access point through the one of the plurality of links in response to reception of the RTS signal or the MU-RTS signal by the wireless signal processing unit before start of the specified period, and
the wireless signal processing unit receives a trigger signal that is transmitted from the access point at start of the specified period and gives an instruction on transmission of uplink data through one of the plurality of links that has transmitted the CTS signal.
